(19) United States
(12) Patent Application Publication
(10) Pub. No.: US 2017/0270555 A1
(43) Pub. Date: Sep. 21, 2017

(54) Client-Side Automated Shopping List Management, Intelligent Coupon Generation and Coupon-Influenced Product Selection

(71) Applicants: Zachary Brandon Zimmerman, Los Angeles, CA (US); Evan Joseph Zimmerman, Los Angeles, CA (US)

(72) Inventors: Zachary Brandon Zimmerman, Los Angeles, CA (US); Evan Joseph Zimmerman, Los Angeles, CA (US)

(21) Appl. No.: 15/074,895

(22) Filed: Mar. 18, 2016

(51) Int. Cl. G06Q 30/02; G06Q 30/06

(52) U.S. Cl. CPC G06Q 30/0224; G06Q 30/0635

(57) ABSTRACT

Client and server transaction agent coupon database interfaces are disclosed. The server transaction agent operations include receiving a shopping list from the client transaction agent, the shopping list specifying one or more product or service items and representing a coupon query initiated by the client transaction agent, formulating a coupon database query requesting coupons associated with some or all of the items specified in the shopping list, querying a coupon database and receiving coupons in response, selecting some or all of the coupons, and sending the selected coupons to the client transaction agent as a coupon query response. The client transaction agent operations include creating the shopping list in electronic form, sending the shopping list as a coupon query to the server transaction agent acting as a coupon database interface, and receiving the selected coupons from the server transaction agent as a coupon query response.

### BACKGROUND

1. Field

The present disclosure relates to the automation of activities associated with the selection and purchase of retail products and services. More particularly, the disclosure is directed to automated shopping list management and utilization, intelligent coupon generation, coupon-influenced product selection and coupon redemption.

2. Description of the Prior Art

By way of background, there are various automated systems and techniques that support activities associated with the selection and purchase of retail products and services. For example, shopping list software exists that allows individuals to specify items to be purchased at a grocery store. Examples of such software include simple text editors, check-box forms, and meal planning tools that can generate grocery lists based on recipe ingredients. As far as known, the goal of existing shopping list software is simply to create a shopping list identifying items to be obtained while shopping. The software is not intended to support any other shopping-related decision-making, such as selecting between competing products that may be offered under different brands and/or by different retailers.

One factor that may influence product selection is the availability of coupons that affect the final price to be paid for purchased items. Coupon acquisition is typically performed prior to shopping, either before or after making a shopping list. With the advent of the Internet, shoppers have access to an assortment of resources for acquiring coupons on products and services of interest. For example, there are websites specializing in coupon distribution that maintain up-to-date electronic databases of coupons for a wide variety of products and services. The webpages served by these websites represent database search interfaces that allow relevant coupons stored in the databases to be identified using various search techniques, including searching by category (area of interest), product type, brand name, etc. Most large retailers have similar websites where coupons covering current inventory items may be obtained. Brand manufacturers also typically maintain websites for obtaining brand-specific coupons.

A common feature of existing web-based coupon acquisition techniques is that their database search interfaces require users to manually identify coupons of interest. Although search tools are provided to facilitate ease of use, a separate search is typically required for each coupon that is ultimately selected. Acquiring coupons in this manner is time consuming and an inefficient use of network bandwidth and data processing resources. Moreover, it is unlikely that a user will obtain the best possible savings. For example, a user searching for a coupon on a particular brand of product may find a coupon for the brand, but may be unaware of coupons for competitive brands that offer better discounts. As such, there is no ability to efficiently support coupon-influenced product selection.

The present disclosure is directed to a improvements in the field of automated shopping support. In particular, the present disclosure provides advancements in shopping list management and utilization, intelligent coupon generation, coupon-influenced product selection, and point-of-purchase coupon redemption.

### SUMMARY

A method, system and computer program product are provided for implementing a client transaction agent coupon database interface. In accordance with example client transaction agent operations, a shopping list is created in electronic form. The shopping list specifies one or more product or service items. The shopping list is sent to a server transaction agent acting as a coupon database interface, with the shopping list serving as a coupon query initiated by the client transaction agent. Selected coupons are received in electronic form from the server transaction agent as a response to the client transaction agent's coupon query. The selected coupons are associated with some or all of the items specified in the shopping list.

In an embodiment, the example client transaction agent operations may further include informing the server transaction agent of a point-of-purchase location where the items specified in the shopping list will be purchased.

In an embodiment, the example client transaction agent operations may further include responding to one or more user inputs by denoting one or more of the selected coupons as coupons that have been chosen for coupon redemption, and responding to a further user input by presenting the chosen coupons as part of a coupon redemption operation.

In an embodiment, the example client transaction agent operations may further include notifying the server transaction agent of one or more of the selected coupons that have been chosen for redemption, and performing an action to update the shopping list based on items that have been chosen for purchase.

In an embodiment, the shopping list may be associated with one or more client transaction agent users with whom the shopping list is to be shared.

In an embodiment, status indicators may be are associated with the product or service items, the status indicators indicating a level of the items available to a user of the client transaction agent.

In an embodiment, the status indicators are selected from the group consisting of flag indicators, numeric indicators and qualitative indicators.

### BRIEF DESCRIPTION OF THE DRAWINGS

The foregoing and other features and advantages will be apparent from the following more particular description of example embodiments, as illustrated in the accompanying Drawings.

FIG. 1 is a functional block diagram showing an example operational environment according to the present disclosure in which one or more client transaction agents communicate with a server transaction agent that in turn communicates with one or more coupon databases.

FIG. 2 is a functional block diagram showing example data processing hardware components that may be used to implement example embodiments of the client transaction agent(s) and the server transaction agent shown in FIG. 1.

FIG. 3 is a flow diagram illustrating example operations and interactions that may be implemented by the client transaction agent(s), the server transaction agent and the database(s) of FIG. 1.

FIG. 4 is a diagrammatic representation of an example user interface for an example client transaction agent, the user interface being in a home view mode and enabling access to a list of shopping lists.

FIG. 5 is a diagrammatic representation of an example user interface for an example client transaction agent, the user interface being in a home view mode and displaying a list of named shopping lists.

FIG. 6 is a diagrammatic representation of an example user interface for an example client transaction agent, the user interface being in a home view mode and displaying a list of unnamed shopping lists.

FIG. 7 is a diagrammatic representation of an example user interface for an example client transaction agent, the user interface being in a home view mode and enabling the management of shopping list users.

FIG. 8 is a diagrammatic representation of an example user interface for an example client transaction agent, the user interface being in a home view mode and displaying a shopping list.

FIG. 9 is a diagrammatic representation of an example user interface for an example client transaction agent, the user interface being in a home view mode and enabling editing of a shopping list.

FIG. 10 is a diagrammatic representation of an example user interface for an example client transaction agent, the user interface being in a store view mode and displaying items having associated coupons, the user interface also enabling coupons to be selectively viewed or chosen for redemption, and further enabling selective viewing of a basket of items selected for purchase.

FIG. 11 is a diagrammatic representation of an example user interface for an example client transaction agent, the user interface being in a store view mode and displaying a basket of items selected for purchase, with the basket being editable to remove one or more of the items.

FIG. 12 is a diagrammatic representation of an example user interface for an example client transaction agent, the user interface being in a store view mode and displaying a coupon for a shopping list item.

FIG. 13 is a diagrammatic representation of an example user interface for an example client transaction agent, the user interface being in a store view mode and displaying an item having an associated coupon that has been chosen for redemption.

FIG. 14 is a diagrammatic representation of an example user interface for an example client transaction agent, the user interface being in a store view mode and displaying a basket of chosen coupons, with the coupons being depicted in a coded machine readable format.

FIG. 15 is a diagrammatic illustration showing example computer readable data storage media that may be used to provide a computer program product in accordance with the present disclosure.

### DETAILED DESCRIPTION OF EXAMPLE EMBODIMENTS

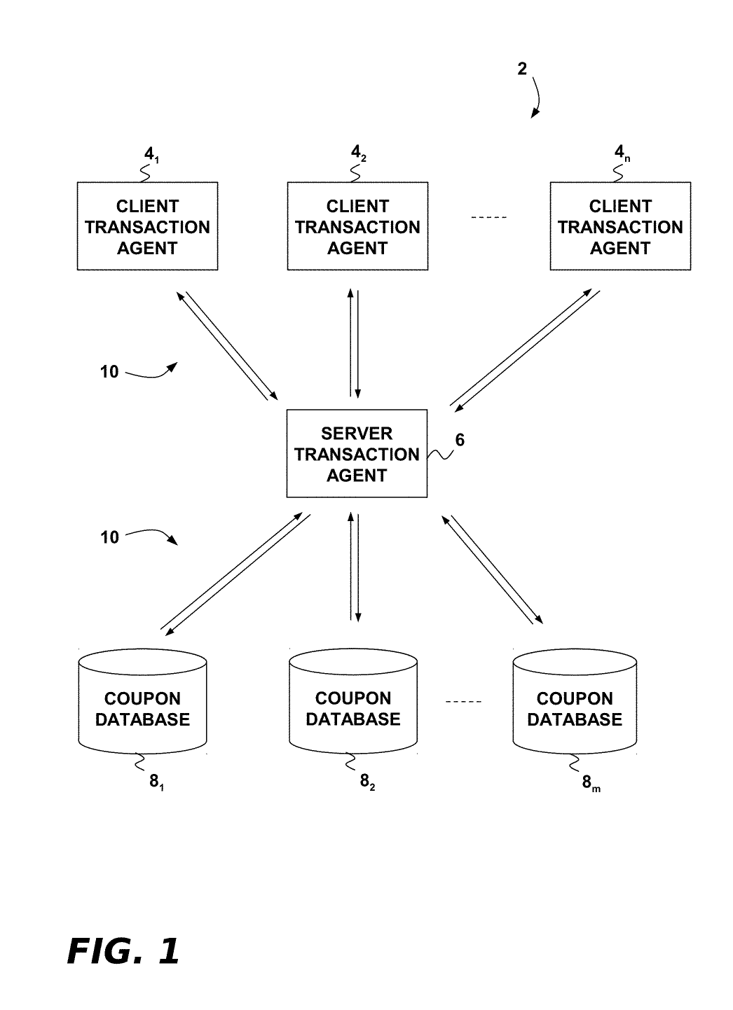

Turning now to the figures, wherein like reference numerals represent like elements in all of the several views, FIG. 1 illustrates an example operational environment 2 that facilitates automated shopping list management, intelligent shopping list-based coupon generation, coupon-influenced product selection and point-of-purchase coupon redemption. In the illustrated embodiment of FIG. 1, the operational environment 2 includes one or more client transaction agents 4 that communicate with a server transaction agent 6, that in turn communicates with one or more coupon databases 6. By way of example, and not limitation, FIG. 1 illustrates the operational environment 2 in a state in which there are plural client transaction agents 4₁, 4₂ . . . 4ₙ, a single server transaction agent 6, and plural coupon databases agents 8₁, 8₂ . . . 8ₙ, with “n” and “m” representing any integer number. It will be appreciated that this operational environment state may change according to the number of client transaction agents 4 and coupon databases 8 that are present at any given time. Various communication pathways between the client transaction agents 4, the server transaction agent 6 and the coupon databases 6 are indicated by reference number 10 in FIG. 1.

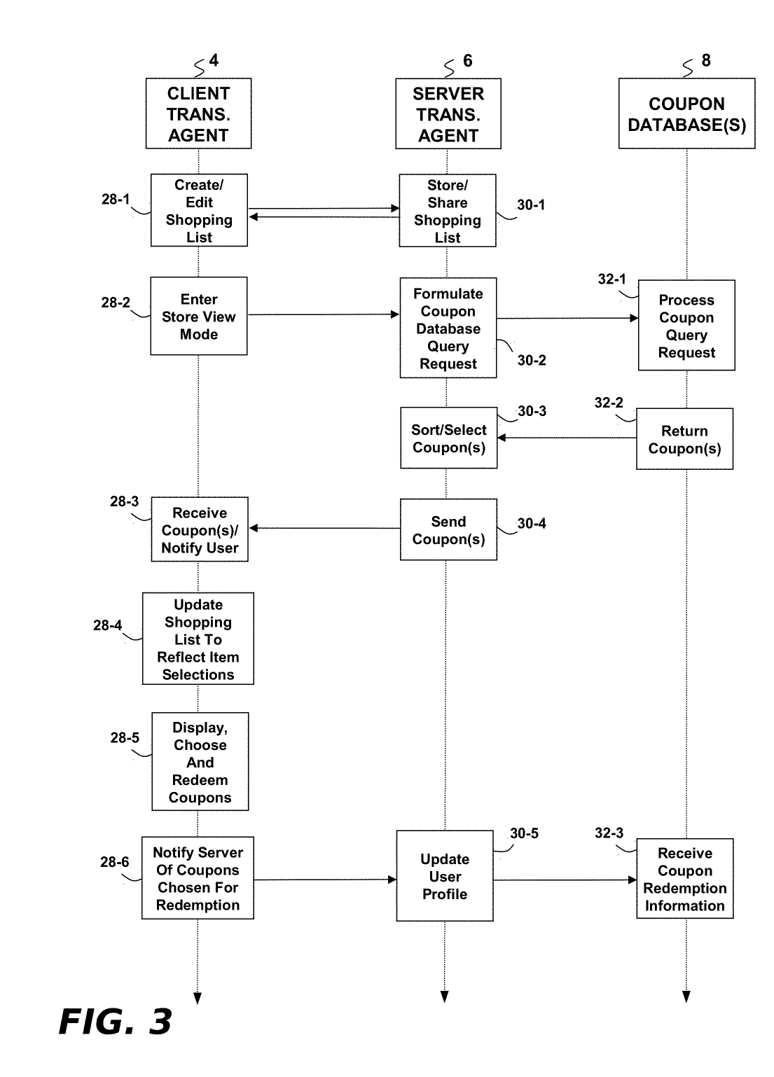

As described in more detail below in connection with FIG. 3, the client transaction agents 4 are intended to be used by shoppers and/or shopping list creators. The client transaction agents 4 facilitate the creation and editing of electronic shopping lists specifying one or more product or service items. The client transaction agents 4 are further operable to send such shopping lists as coupon database queries to the server transaction agent 6, receive selected coupons from the server transaction agent that are associated with some or all of the items on the shopping lists, and support coupon-based product selection and coupon redemption at a point of purchase.

In the illustrated embodiment, some or all of the client transaction agents 4 may be implemented as hand-held data processing devices capable of wireless communication. Devices of this type include but are not necessarily limited to computerized mobile telephones (e.g., “smartphones”), digital tablets, personal digital assistants, portable entertainment systems, etc. In other embodiments, one or more of the client transaction agents 4 may be implemented as data processing devices that are not designed for hand-held use, such as laptop computers and even desktop computers and work stations. Such devices could be used to perform at least some of the client transaction agent operations described herein, such as creating and editing a shopping list, and forwarding the same to the server transaction agent 6.

As described in more detail below in connection with FIG. 3, the server transaction agent 6 is a network-connected server that acts as a coupon database interface to receive shopping lists in electronic form as coupon queries from the client transaction agents 4. Each shopping list specifies one or more product or service items. The server transaction agent 6 formulates one or more coupon database queries and submits those queries to one or more of the coupon databases 8 in order to obtain coupons associated with some or all of the items specified in the shopping list. Such coupons are received in electronic form as query results from the coupon database(s) 8, and the server transaction agent 6 selects some or all of the coupons based on predetermined criteria. The selected coupons are sent in electronic form to a client transaction agent 6 that is associated with the shopping list.

In an example embodiment, the server transaction agent 6 may be implemented as a server-class data processing system using real and/or virtualized computing resources. Although the server transaction agent 6 is shown as a single functional entity in FIG. 1, its physical implementation may that of a distributed system, possibly based on a multitier architecture. For example, a three-tier architecture could be used in which (1) a first tier provides a front end service interface for the client transaction agents 4, (2) a second tier performs operational processing associated with shopping list management and intelligent coupon generation, and (3) a third tier provides database storage of shopping lists, user profile information, and possibly coupons. In the latter instance, the database tier of a multitier server transaction agent 6 could provide one or more of the coupon databases 8. If desired, the server transaction agent 6 could utilize a suitable server clustering technology to provide scalability, redundancy and other benefits.

As described in more detail below in connection with FIG. 3, the coupon databases process coupon queries received from the server transaction agent 6, and return coupons to the server transaction agent as query results. In an example embodiment, the one or more coupon databases 8 may be implemented using database servers managing a data storage system or infrastructure that stores coupons in electronic form. To facilitate access to the stored coupons, the database servers may implement suitable DBMS (Database Management System) software. The DBMS software may provide standard query interfaces, including but not limited to an SQL (Sort Query Logic) front end, a key-word search interface, etc., that the server transaction agent 6 may utilize to submit its coupon database queries. As previously discussed, one or more of the coupon databases 8 could be associated with the server transaction 6, such as part of a server database tier in a server implementation having a multitier architecture. Such a coupon database would typically be commonly owned and/or operated with the server transaction agent 6. Other coupon databases 8 could be separate and distinct from the server transaction agent 6. These coupon databases 8 may include but are not limited to public coupon databases operated by third parties such coupon distributors, stores, brand manufacturers, etc.

The communication pathways 10 shown in FIG. 1 may be implemented in various ways. Typically, the communication pathways 10 between the client transaction agents 4 and the server transaction agent 6 will be provided by some combination of public network resources, such as the Internet, and private network resources, such as cellular network or local area wireless (Wi-Fi) network that supports wireless data communication. The communication pathways 10 between the server transaction agent 6 and the coupon databases 8 will in many cases be provided by public network resources, such as the Internet, but could also be provided by private network resources, such as when a coupon database 6 is part of a database tier of a multitier server transaction agent 6.

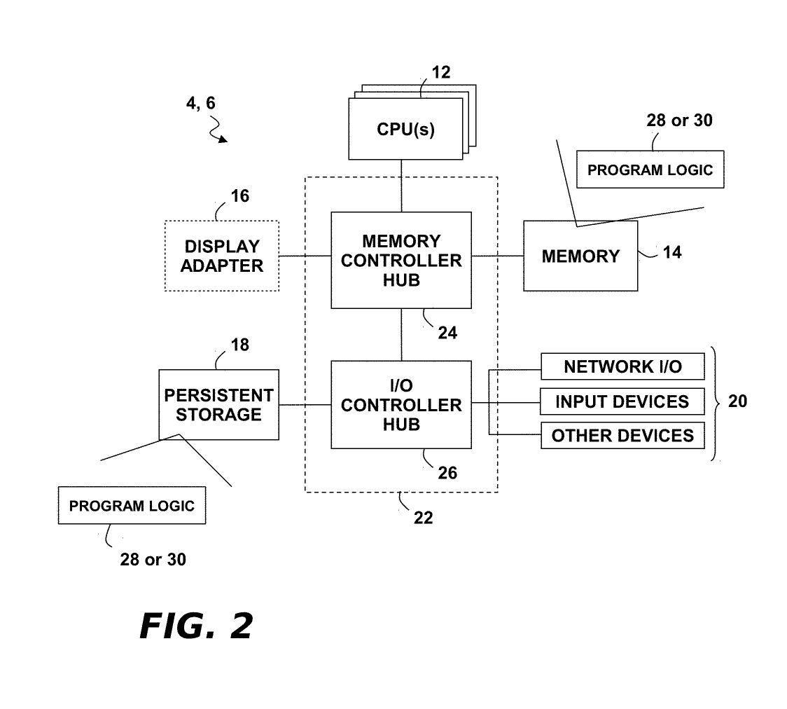

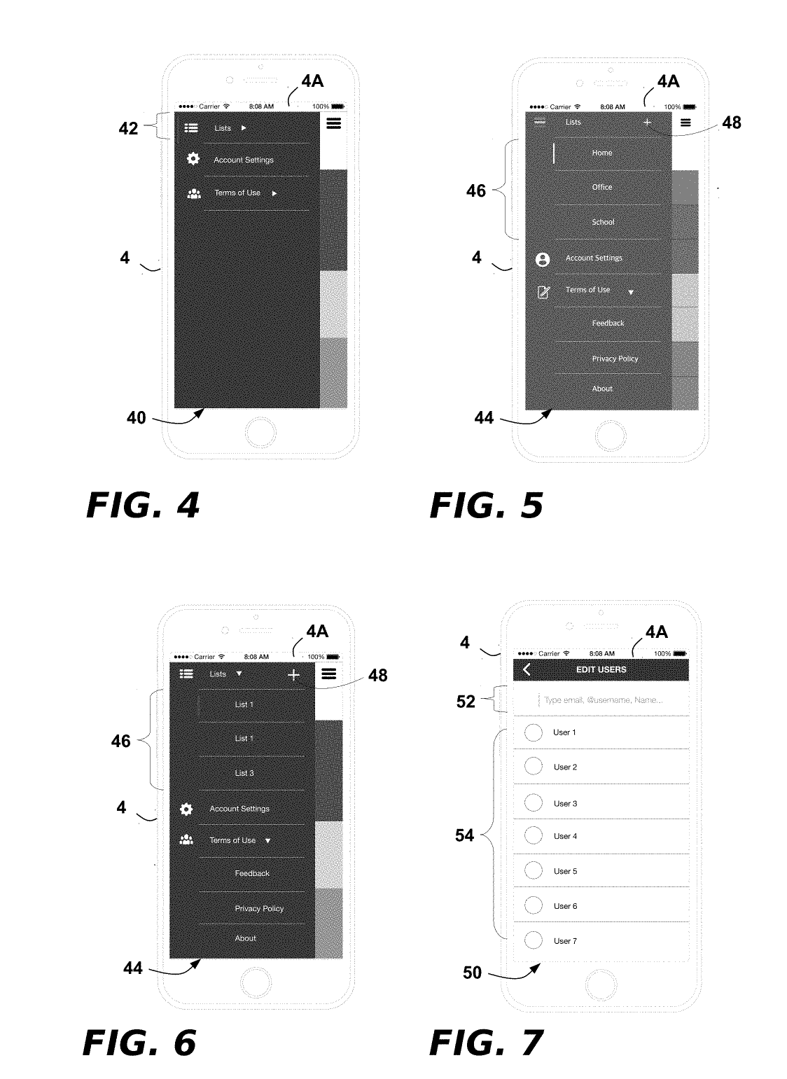

FIG. 2 illustrates example hardware components that may be used to implement both the client transaction agents 4 and the server transaction agent 6. The hardware components of FIG. 2 are illustrated as including one or more CPUs or other logic-implementing hardware 12 that may operate in conjunction with a memory 14 (e.g., RAM, ROM, or a combination thereof) to provide a data processing core. An additional component that may be provided in the client transaction agents 4, but is optional in the case of the server transaction agent 6, is a display adapter 16 for generating visual output information (e.g., text and/or graphics) to an associated display (not shown in FIG. 2). Additional components shown in FIG. 4 include a persistent data storage resource 18 (e.g., a disk drive, a solid state drive, flash storage, etc.) and various peripheral devices 20. The peripheral devices 20 may include conventional I/O resources, such as a network I/O device (Ethernet, WiFi, Cellular, etc.). At least in the case of the client transaction agents 4, the peripheral devices 20 may further include an input device such as a touch screen, a keyboard (real or virtual), and possibly a pointing device (in client transaction agents that support such functionality). Other types of peripheral devices 20 may also be provided, as needed. A bus infrastructure 22, which may include a memory controller hub or chip 24 (e.g., a northbridge) and an I/O (input/output) controller hub or chip 26 (e.g., a southbridge), may be used to interconnect the foregoing components. It should be understood that the above-described hardware components are set forth as examples only, and that other suitable hardware components and component arrangements may also be used to implement the client transaction agents 4 and the server transaction agent 6.

FIG. 2 additionally shows program logic 28 or 30 that may be permanently stored in the persistent data storage resource 18 (or elsewhere) and loaded in the memory 14 during program execution. As will now be described in connection with FIG. 3, the program logic 28 is implemented by the client transaction agents 4, and the program logic 30 is implemented by the server transaction agent 6.

Turning now to FIG. 3, various example operations are shown that may be respectively performed by the client transaction agents 4, the server transaction agent 6 and the coupon databases 8. Although these operations are depicted as apparently occurring in a top-to-bottom order in FIG. 3, this is merely to facilitate ease of description. It should thus be understood that the operations of FIG. 3 may be performed in any suitable order. Moreover, operations that are depicted as apparently occurring at different times may in fact be performed at the same time. In addition, operations that appear to be performed once may be repeated several times, possibly as part of an iterative process. For example, operations 28-1 and 30-1 may be performed repeatedly and iteratively between one or more client transaction agents 4 and the server transaction agent 6 as part of creating and updating a shopping list.

In an example embodiment, the operations performed by the client transaction agent 4 may be implemented as part of two distinct modes of operation, namely a home view mode and a store view mode. Operation 28-1 is associated with the home view mode whereas operations 28-2 through 28-7 are associated with the store view mode. In general, the home view mode is for shopping list creation and management while the store view mode is for shopping list utilization, coupon-influenced product selection and coupon redemption.

Operation 28-1 in FIG. 3 may be periodically performed by any of the client transaction agents 4 as part of the home view mode. During operation 28-1, a client transaction agent's program logic 28 performs client-side shopping list management in response to input by a transaction client user. As used herein, client-side shopping list management may include creating/editing shopping lists as well as creating/editing lists of users representing user groups with whom the shopping lists are shared (e.g., per operation 30-1 as described in more detail below). Each client transaction agent 4 may manage multiple shopping lists. Moreover, any given shopping list may be managed by a set of client transaction agents 4 belonging to the members of a user group that shares the shopping list. This assumes that such a group exists, and it will be beneficial to clarify at this point that the present disclosure contemplates shopping lists being created and used by either a single individual user or by a group of users.

In situations were a shopping list is being edited by a particular client transaction agent user, the shopping list may have been previously created by the same client transaction agent 4 operated by the same user. Alternatively, the shopping list may have been created by a different client transaction agent 4 operated by a different user who may be a member of a user group that includes the first user. A user group may constitute any group entity that purchases goods or services for use by the group members. Examples include but are not limited to members of a household, members of an organization, etc. As noted above, shopping list management as implemented by the program logic 28 as part of operation 28-1 may including creating/editing lists of users that define the user groups who share shopping lists. Further details of shopping list sharing are discussed below in connection with operation 30-1 of FIG. 3.

As part of operation 28-1, the program logic 28 of a client transaction agent 4 may generate various home view mode user interfaces on a client transaction agent screen display. In an example embodiment, the home view mode user interfaces may include but are not limited to the example interfaces shown in FIGS. 4-9. Other embodiments may of course use entirely different user interfaces for the home view mode, with the user interfaces being of any desired number or type.

In FIG. 4, an example first user interface 40 is generated in a display 4A of a client transaction agent 4 while the latter is in the home view mode. The user interface 40 includes a user interface field 42 (which may be named “Lists”) that enables a user to view a set of one or more list identifiers that identify the shopping lists being managed by the program logic 28. Selecting the user interface field 42 using an appropriate user interface action will result in the program logic 28 displaying a list of shopping lists, as shown for example in FIG. 5.

In FIG. 5, an example second user interface 44 is generated in a display 4A of a client transaction agent 4 while the latter is in the home view mode. The user interface 42 includes a set of shopping list name fields 46 that identify the shopping lists being managed by the program logic 28. In this case, the shopping lists have been previously created and named. These names may reflect the fact that each shopping list can serve a different purpose. Each shopping list may thus specify one or more product or service items that are used in a particular setting. In FIG. 5, an example “Home” shopping list is shown that could be used for household products. An example “Office” shopping list is additionally shown that could be user for office supplies. An example “School” shopping list is further shown that could be used for school supplies.

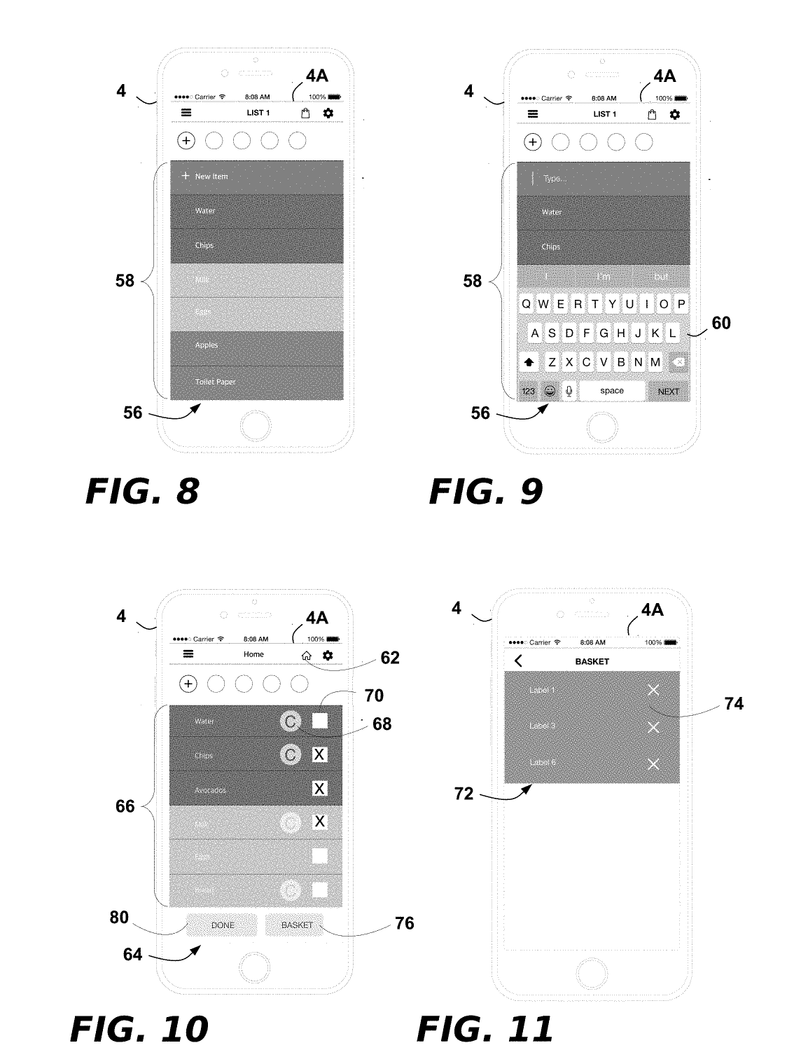

Selecting any of the shopping list name fields 46 in the user interface 44 using an appropriate user interface action will result in the program logic 28 displaying an associated shopping list, as shown for example in FIG. 8 (discussed in more detail below). The user interface 44 thus supports accessing shopping lists and switching between lists. The program logic 28 may also support editing the names of the shopping lists, such as in response to a different user interface action on the shopping list name fields 46. In addition, the user interface 44 of FIG. 5 may further include a control element 48 (depicted in FIG. 5 as a “+” sign) for creating additional shopping lists with associated list name fields 46.

As noted above, the shopping lists shown in the user interface 44 of FIG. 5 have been previously named. FIG. 6 shows an alternative view of the user interface 44 as it might appear in a default state prior to any shopping lists being created. In this state, one or more shopping list name fields 46 may have default names, such as “List 1,” List 2,” and “List 3.” If desired, a pre-determined number of shopping list name fields 46 (e.g., three fields) for creating a corresponding number of shopping lists (e.g., three lists) may be provided by default. The user interface element 48 may be used to create additional shopping lists if so desired. The client transaction agent's program logic 28 may additionally support deleting a shopping list, such as in response to an appropriate user interface action performed in the corresponding shopping list name field 46.

In FIG. 7, an example third user interface 50 is generated in the display 4A of a client transaction agent 4 while the latter is in the home view mode. The user interface 50 includes a user information field 52 and a set of user selectors 54. These user interface fields may be used to create and manage a user group that shares a shopping list being managed by the client transaction agent program logic 28. Each shopping list may have its own set of user group members with whom the shopping list will be shared (e.g., per operation 30-1 as described in more detail below). Thus, the program logic 28 may be configured so that the user interface 50 is displayed in relation to a particular shopping list. The user interface 50 may be used to add and delete users or to edit their user information as displayed in the user information field 52. By way of example, such user information may include a user name, email address, etc.

In FIG. 8, an example fourth user interface 56 is generated in the display 4A of a client transaction agent 4 while the latter is in the home mode. The user interface 56 includes a set of item fields 58 for specifying individual product or service items of a shopping list, with the entire set of fields representing the shopping list itself. The item fields 58 may identify the shopping list items generically, descriptively and/or by brand name. FIG. 8 illustrates an embodiment in which the shopping list items are identified generically.

An optional feature of the user interface 56 of FIG. 8 is that the item fields 58 of a shopping list may be displayed with an editable item status indicator that denotes the item as having a particular status. For example, a shopping list item might have an associated inventory status that ranks the item according to how many units of the item a user or user group has left in an inventory. In an embodiment, the status indicator for an item might be a two-state indicator (e.g., a flag) that indicates whether or not any units of the item are in the inventory. In another embodiment, the status indicator for an item might be a multi-state indicator (e.g. a variable) that indicates how many units of the item remain in the inventory. In such an embodiment, the multi-state status indicator could be a specific unit count or a more generalized qualitative quantifier indicating, for example, that the inventory is fully stocked with the item, is running low on the item, or has no units of the item.

One way that a shopping item status indicator could be implemented as a qualitative quantifier would be to display the status indicator as a color, such as in the background of the item fields 58 of FIG. 8. In such an embodiment, the color green might be used to indicate that an item is fully stocked in inventory, the color yellow could be used to indicate that an item is running low in inventory, and the color red may be used to indicate that an item has been exhausted from inventory. In FIG. 8, the item fields 58 are shaded to indicate that different items may have different colors indicating different status. For example, the shading in the top two named item fields 58 could correspond to the color red to indicate that these items are not in inventory, the shading of the middle two named item fields 58 could correspond to the color yellow to indicate that these items low in inventory, and the shading of the lower two named item fields 58 could correspond the color green to indicate that these items are fully stocked in inventory.

Using editable item status indicators to indicate the inventory status of items in a shopping list has certain advantages. One advantage relates to how the shopping list is used during a shopping excursion (e.g., while the client transaction agent is in the store view mode as described in more detail below). By referring to the item status indicators, the shopper may wish to limit shopping to items that have been exhausted from an inventory, while ignoring items that merely have a low or fully stocked inventory status.

Another advantage of using editable item status indicators relates to how the shopping list is modified during a shopping excursion in response to shopping list items being selected for purchase. If status indicators are used, the program logic 28 may automatically update the shopping list to change a selected item's status, e.g. from “not in inventory” to “fully stocked.” Without status indicators, the user might need to delete the items selected for purchase from the shopping list as a means of verifying (e.g., to the user or other members of a user group) that the items are being purchased. In such an embodiment, if items are deleted from a shopping list as a result of a shopping excursion, a new list might have to be created (or perhaps restored from a template) for each shopping excursion. On the other hand, if status indicators are used, the same shopping list may be used for subsequent shopping excursions merely by resetting the status indicators. Changing the status indicators thus provides a way to make rolling updates to the same shopping list.

A further advantage of using editable item status indicators is that the status indicators can be used to confine coupon database queries to items that are likely to be purchased, such as items that have low unit counts in an inventory. Here, the assumption is that the shopper is not likely to purchase items whose status indicator indicates there is no need for item replenishment. Of course, if the shopper does wish to acquire a coupon for such an item (e.g., to see if any discounts are available that might warrant purchasing excess units of the item), provision can be made for editing the shopping list while the client transaction agent 4 is in the store view mode, as described in more detail below.

In FIG. 9, the user interface 56 shown in FIG. 8 is modified in response to a user performing a user interface action for adding a new shopping list item. For example, the user could select the first item field 58, which is labeled “+ New Item” in FIG. 8. This may result in the first item field 58 becoming a text entry field and a virtual keyboard 60 being displayed for typing the name of the product. If status indicators are used, the user may assign an appropriate status to the item.

Returning now to FIG. 3, each occurrence of operation 28-1 that results in a shopping list being created or updated may conclude with the newly-created or updated shopping list being sent to the server transaction agent 6. This may trigger the server transaction agent 6 to implement operation 30-1 of FIG. 3. As described in more detail below, an embodiment may be implemented in which a client transaction agent 4 sending a shopping list to the server transaction agent 6 may also explicitly request that the server transaction agent treat the shopping list as a coupon query and additionally implement operations 30-2, 30-3 and 30-4. An implicit request to treat a shopping list as a coupon query could also be made, such as by way of user profile information for a client transaction agent user. One motivation for making early coupon queries is to allow the client transaction agent 4 to receive and cache coupons prior to a shopping excursion as a contingency against future service delays or interruptions. However, in a typical operational scenario, a shopping list will not be treated as a coupon query by the server transaction agent 6 until an associated client transaction agent enters the store view mode per operation 28-2 (see below).

The operation 30-1 may be periodically performed by the server transaction agent 6 in response to receiving new shopping lists or updated versions of existing shopping lists from the client transaction agents 4. During operation 30-1, the server transaction agent's program logic 30 performs server-side shopping list management. As used herein, server-side shopping list management may include storing a master copy of each shopping list associated with a particular user or user group, as well as sharing user copies of shopping lists with transaction agents 4 used by members of shopping list user groups. Shopping list master copies may be stored by server transaction agent 6 in any suitable storage location. For example, the persistent data storage resource 18 of FIG. 2 could be used as a shopping list master copy data store. Alternatively, as previously discussed, the server transaction agent 6 may include a database where shopping list master copies may be stored, such as when the server transaction agent is implemented with a multitier server architecture that includes a database tier. In a further alternative embodiment, the server transaction agent 6 could store shopping list master copies in a remote data storage, such as a cloud storage system.

The program logic 30 of the server transaction agent 6 may share shopping lists among members of a shopping list user group by pushing new and updated shopping lists to client transaction agents 4 associated with the group members. Such push events may be performed each time a new shopping list is created or an existing shopping list is updated. The server transaction agent 6 may identify shopping list group members in various ways, such as by maintaining associations between shopping lists and the group members. In an embodiment, the shopping list-group member associations could be maintained by appending group member identifications to the shopping lists themselves. Other embodiments might use searchable tables or the like to store the shopping list-group member associations. As noted above, group member user identification information may be specified via the user interface 50 shown in FIG. 7. Alternatively, the client transaction agents 4 could specify shopping list group member identifications to the server transaction agent 6 in other ways, such as via an appropriate API (not shown) implemented by the program logic 30 for receiving user profile information.

By receiving, storing and sharing shopping lists as described above, the server transaction agent 6 may support useful interactions between user group members involving a common shopping list and an associated inventory of shopping list items, allowing each group member to have a say in what items will be purchased using the shopping list on behalf of the group. Between each shopping excursion, group members may add or delete shopping list items, or perhaps change an item's status if such functionality is provided, as items in an inventory are consumed. For example, if a household member notices that a supply of apples is dwindling, or has been exhausted, he/she may use their client transaction agent 4 to edit the group shopping list. In an embodiment, the client transaction agent 4 may send the newly updated version of the shopping list to the server transaction agent 6, and the latter may push the update to the client transaction agents 4 of other group members while storing the update as a new shopping list master copy.

Turning now to operation 28-2 of FIG. 3, a client transaction agent 4 associated with shopper may be is placed in store view mode as the shopper arrives at a shopping venue. This may happen in several ways. For example, if the client transaction agent 4 supports location services, it may report its location to the server transaction agent 6, and the latter may use the location information to detect that the client transaction agent is at or near a recognized retail venue. The server transaction agent 6 may then signal the client transaction agent 4 to enter the store view mode. Alternatively, in the event that the client transaction agent 4 does not support location services, or if it otherwise fails to inform the server transaction agent 6 of its location, the client transaction agent may be manually placed in the store view mode. For example, as shown in FIG. 10, a user interface element 62 may be provided for this purpose. When the client transaction agent 4 is manually placed in the store view mode, its program logic 28 may inform the server transaction agent 6 of the mode change.

When the client transaction agent 4 enters the store view mode in operation 28-2, the the server transaction agent 6 may process the latest version of the shopping list associated with that client transaction agent as a coupon query from the client transaction agent. The server transaction agent 6 thus assumes the role of a coupon database interface on behalf of the client transaction agent 4. The coupon query may be processed by the server transaction agent 6 even if a coupon query was previously explicitly or implicitly requested by a client transaction agent 4 during operation 28-1, such as for coupon caching purposes as described above. Assuming fresh coupons are successfully received as a result of the new coupon query made upon entering the store view mode, they may replace any corresponding previously cached coupons. As further discussed in more detail below, if any updates are made to the shopping list to add additional items while in the store view mode, such updates may be treated as additional targeted coupon queries by the server transaction agent 6, and processed accordingly to retrieve coupons related to the newly-added items.

In block 30-2 of FIG. 3, the server transaction agent 6 has entered a coupon database search mode relative to a given shopping list. During the coupon database search mode, the server transaction agent 6 formulates one or more coupon database queries based on the shopping list. The coupon database query(ies) may seek to obtain coupons for some or all of the items on the shopping list from any number of the coupon databases 8. The coupon database query(ies) may be formulated based on item identifiers, such as key words, that identify the shopping list items. In an embodiment, the item identifiers could be generic identifiers or product descriptions. In another embodiment, the item identifiers could be brand names. In a further embodiment, the shopping list items might be identified using a mixture of generic and brand names, and the coupon database query(ies) may be formulated based on either format.

In order not to miss potentially applicable retailer coupons, and to ensure that non-retailer coupons are allowed by a particular retailer, the formulation of coupon database query(ies) may take into account point-of-purchase location information where the client transaction agent 4 will be used. This information may be obtained directly from the client transaction agent 4 if the latter supports location services. Alternatively, a point-of-purchase location could be specified to the server transaction agent 6 in other ways, such as, without limitation, by identifying a preferred shopping venue in a client transaction agent's shopping list. Alternatively, or in addition, the server transaction agent 6 could maintain user profile information for client transaction agent users and user groups. This user profile information could indicate a preferred shopping venue where a particular shopping list will be used. An example of this would be when a user routinely buys groceries at the same supermarket.

The above-mentioned user profile information may include additional data that may be used by the server transaction agent 6 to formulate coupon database query(ies). Such additional data may include any information that aids the server transaction agent 6 search for relevant coupons, including but not limited to purchase history information, coupon usage information, demographic information, etc. The server transaction agent 6 may use data analytics algorithms to develop the purchase history and coupon history information. The demographic information may be obtained by implementing a registration system whereby client transaction agents 4 are required to register in order to interact with the server transaction agent 6.

The server transaction agent 6 may maintain user profile information in any suitable manner. For example, user demographic information could be stored in a user registration data store. Profile information such as purchase history and coupon history, which evolves over time, could likewise be stored in a suitable data store. Such information could also be maintained as metadata associated with shopping lists. In an embodiment, each shopping list item could have associated user profile metadata, including but not limited to an identification of (1) the user who created the item, (2) the users who have purchased the item, (3) the locations where the item has been purchased, (4) the coupons that have been previously used with the item, etc.

When the server transaction agent 6 has formulated one or more coupon database queries, the query(ies) may be sent to one of more of the coupon databases 8. The coupon database(s) 8 selected for querying may be determined as part of formulating the one or more coupon database queries. Each coupon database query will be in a format that is database-specific, meaning that the query conforms to whatever query format the database's DBMS query interface supports, whether it be SQL queries, key-word queries, or otherwise.

In operation 32-1 of FIG. 3, one or more of the coupon databases 8 receives one or more of the coupon database queries from the server transaction agent 6, and performs responsive coupon database-specific query processing. Insofar as this coupon database query processing is conventional in nature, it need not be further described herein. In operation 32-2, the coupon database(s) 8 that performed the coupon database query processing may return one or more relevant coupons in electronic form to the server transaction agent 6. This is likewise a conventional operation that need not be further described herein.

In operation 30-3 of FIG. 3, the server transaction agent 6 sorts and selects some or all of the coupons returned by the coupon query(ies). The selected coupons may be determined by filtering the coupon query results using predetermined criteria. For example, the predetermined criteria could include any of the above-discussed user profile information, including point-of-purchase location information, purchase history information, coupon history information, and demographic information. The predetermined criteria may also reflect coupon value considerations, an example of which might be that coupons offering the greatest discount values to shoppers are preferred. Note that coupon value considerations could also be used in block 30-2 when formulating coupon queries.

In an embodiment, the predetermined criteria used for filtering coupon query results may vary or evolve over time, e.g., as a result of machine learning. In this regard, the predetermined criteria may take into account randomness, such as by randomly choosing features from a pool of features as in a random forest algorithm.

In an embodiment, the filtering of coupon query results during operation 30-3 may cause a maximum of one coupon to be selected for any given shopping list item. In other embodiments, more than one coupon may be selected for a given shopping list item, such that the user is given a choice of coupons to select. In the trivial case, the filtering of coupon query results might be a “no-op” in which the predetermined criteria consist of a NULL set, i.e., there are no criteria. In that case, all of the coupons received from the coupon databases would be selected, which might include multiple coupons for competing brands of a particular item.

In operation 30-4 of FIG. 3, the server transaction agent 6 sends the selected coupons to the client transaction agent 4 in electronic form. In operation 28-3, the client transaction agent 4 receives the coupons. Assuming the client transaction agent 4 is in the store view mode when the coupons are received, which will typically be the case, the user may be notified that coupons are available. Such notifications may be provided in the manner shown in FIG. 10, which depicts a fifth user interface 64 being generated in the display 4A of a client transaction agent 4 while the latter is in the store view mode. The user interface 64 includes a set of item fields 66 specifying individual items of a shopping list. In addition to the item fields 66 displaying information that identifies shopping list items, each such field may include a coupon indicator 68 that notifies the user whether a coupon is available for the item. In FIG. 10, the coupon indicator is displayed using the letter “C.” Four of the items in the shopping list are shown as having associated coupons, while two item do not have coupons. It will be appreciated that other types of coupon indicator could also be used.

It should be noted at this point that the shopping list items displayed while a client transaction agent 4 is in the home view mode may differ from the items displayed in the store view mode. In particular, in an embodiment wherein status indicators are used to denote whether or not items are present in an inventory, items that do not need replenishing may be masked in the store view mode, so as not to be displayed. For example, if the color green is used to denote fully stocked items of a shopping list displayed in the home view mode, the green items may not be displayed in the store view mode. In such an embodiment, only yellow items that are low in inventory and/or red items that are exhausted from inventory might be displayed.

In operation 28-4 of FIG. 3, the user interface 64 of FIG. 10 may be utilized for updating a shopping list to reflect items selected for purchase. One way this could be implemented is to provide a product selector check box 70 in each of the item fields 66. When a product is selected for purchase, the user may mark the product selector check box 70. In FIG. 10, three items have been checked off for purchase. The program logic 28 may be configured to maintain a virtual shopping basket that tracks the selected items. An example user interface 72 displaying a shopping basket 74 is shown in FIG. 11. The user interface 72 may be invoked from the user interface 64 in any suitable manner, such as by providing the user interface element 76 labeled “BASKET” in FIG. 10. In FIG. 11, the shopping basket 74 contains the three items that were checked off in FIG. 10. If desired, the shopping basket 74 may be editable so that items may be removed from the shopping basket in case they were accidentally added or if the user decides not to purchase the item. In FIG. 10, the “X” user interface element associated with each shopping basket item is provided for this purpose. Marking a shopping list to reflect purchased items in the user interface 56 will update the user copy of the shopping list maintained by the client transaction agent 4. As discussed below in connection with operation 28-6, incremental shopping list updates may be sent to the server transaction agent 6 as they are made during a shopping excursion, or a single update may be sent at the end of the shopping excursion.

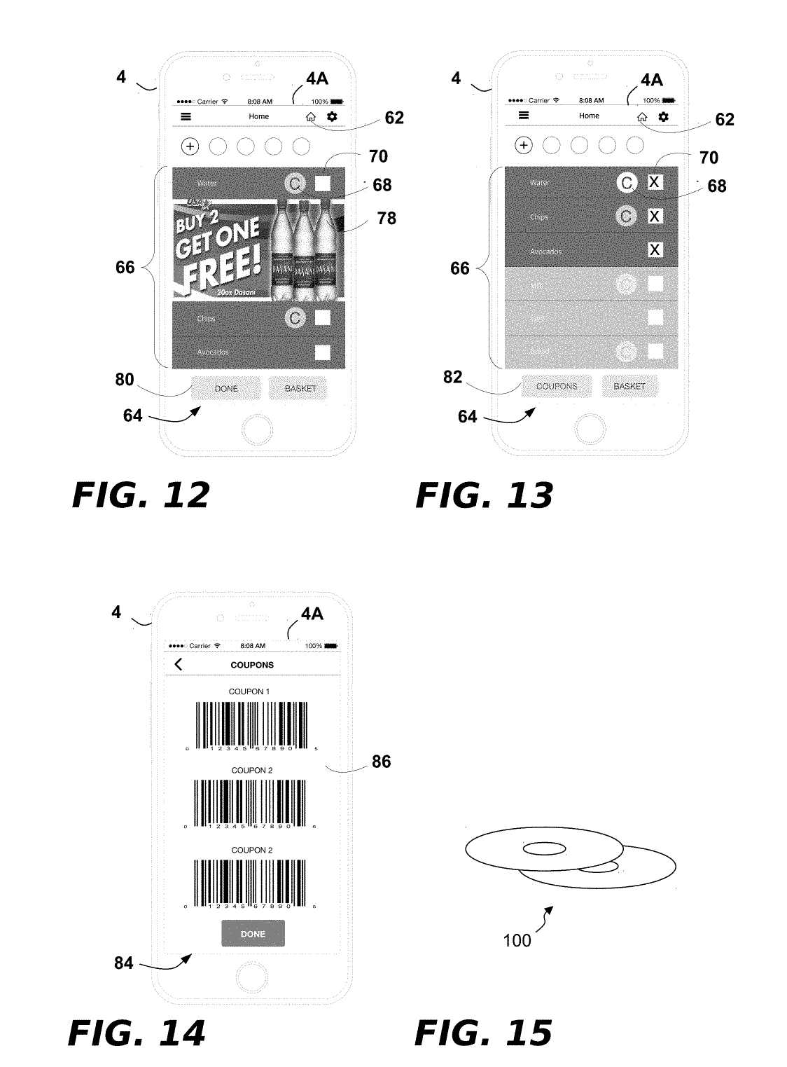

In operation 28-5 of FIG. 3, the user interface 64 of FIG. 10 may be used for displaying, choosing and redeeming coupons. One way that a user might display a coupon would be to perform an appropriate user interface action on the item field 66 for an item having the coupon. FIG. 12 illustrates an example coupon 78 being displayed for the “Water” shopping list item shown in FIG. 10. One way that a user might choose a coupon (for redemption) would be to perform a user interface action on the coupon indicator 68. This is illustrated in FIG. 13, which shows the coupon indicator 68 for the “Water” shopping list item being highlighted. Performing this action may result in the coupon being placed in a coupon basket, as discussed below in connection with FIG. 14. In an embodiment, choosing the coupon for an item may also result in the item being automatically selected for purchase. This is shown for the “Water” shopping list item in FIG. 13, which shows the product selector check box 70 being marked for the “Water” item. Conversely, if an item whose coupon has been chosen is deselected by unmarking the product selector check box 70, the coupon may also be automatically deselected and removed from the coupon basket. If for some reason a user wants to purchase an item without using an available coupon (e.g., they don't want a particular brand to which the coupon applies), the user may check the item's product selector check box 70 without activating the item's coupon indicator 68. This scenario is exemplified by the “Chips” item in FIG. 13.

When the user has finished shopping, he/she may so inform the client transaction agent 4 by activating the “DONE” user interface element 80 of the user interface 64 (shown in FIGS. 10 and 12). When the “DONE” user interface element 80 is activated, it changes into a “COUPONS” user interface element 82, as shown in FIG. 13. Selecting the “COUPONS” user interface element 82 represents one way that coupons may be displayed for redemption. In particular, the user interface 84 of FIG. 14, which includes a coupon basket 86, may be displayed. The coupons are preferably displayed in a machine readable format, such as a bar code, so that the coupons may be easily redeemed by scanning them during checkout. Coupons could also be redeemed in other ways, such as via wireless communication (e.g., near field communication (NFC)) between the client transaction agent 4 and a payment/coupon processing terminal (not shown) at the point-of-purchase location.

In operation 28-6 of FIG. 3, the client transaction agent 4 notifies the server transaction agent 6 of all coupons that were chosen for redemption. In operation 30-5 of FIG. 3, the server transaction agent 6 may use the coupon redemption information to update a user profile associated with a user of the client transaction agent 4 and/or for other purposes. The server transaction agent 6 may also send the coupon redemption information to the coupon database(s) 8 from which the coupons were obtained. Operation 32-3 of FIG. 3 represents the coupon database(s) 8 receiving the coupon redemption information from the server transaction agent. The coupon redemption information exchange could, for example, be used for billing purposes pursuant to service agreements between the owner or operator of the server transaction agent 6 and the owner(s)/operator(s) of the coupon database(s) 8.

Operation 28-6 may further include the client transaction agent 4 advising the server transaction agent 6 of shopping list updates resulting from product selections made while in the store view mode. If status indicators are used to indicate the inventory status of shopping list items, such status indicators may be updated to reflect the fact that units of each purchased item are now in inventory. Such status updates may be sent to the server transaction agent 6 at the end of a shopping excursion, for example, when the client transaction agent 4 exits the store view mode. The server transaction agent 6 may then push the updates per operation 30-1 to additional client transaction agents 4 associated with other members of a shopping list user group, thereby informing the users that shopping list items have been purchased.

Shopping list updates may also occur during a shopping excursion when a user adds items to shopping list while the client transaction agent 4 is in the store view mode. To accommodate such on-the-fly shopping list updates, the client transaction agent's program logic 28 may be configured to promptly send the updated shopping list to the server transaction agent 6. The latter may then formulate an on-the-fly coupon database query and return relevant coupons in a timely manner.

In an embodiment, a client transaction agent 4 may be capable of receiving shopping list updates made by other transaction agents while in the store view mode. This scenario could occur if another group member wanted to advise a group member who is concurrently shopping about additional items that need to be purchased. In a further embodiment, a client transaction agent 4 may allow a user to switch between lists while in the store view mode. This will be advantageous at venues were items from than one list are available, such as certain large chain retailers.

Accordingly, a technique has been disclosed that provides improvements in shopping list management and utilization, coupon database interfaces for coupon acquisition, coupon-influenced product selection, and point-of-purchase coupon cash-in. It will be appreciated that the foregoing concepts may be variously embodied in any of a data processing system, a machine implemented method, and a computer program product in which programming logic is provided by one or more computer readable data storage media for use in controlling a data processing system to perform the required functions. Example embodiments of a machine-implemented method and data processing system were previously described in connection with FIGS. 1-3.

With respect to a computer program product, digitally encoded program instructions may be stored on one or more computer readable data storage media for use in controlling a computer or other information handling machine or device to perform the required functions. The program instructions may be embodied as machine language code that is ready for loading and execution by the machine apparatus, or the program instructions may comprise a higher level language that can be assembled, compiled or interpreted into machine language. Example languages include, but are not limited to C, C++, assembly, to name but a few. When implemented on a machine comprising a processor, the program instructions combine with the processor to provide a particular machine that operates analogously to specific logic circuits, which themselves could be used to implement the disclosed subject matter.

Example computer readable data storage media for storing such program instructions are shown by the memory 14 of the transaction agents 4 and 6 of FIG. 2. The transaction agents 4 and 6 may further include one or more secondary (or tertiary) storage devices, such as the persistent data storage resource 18 of the transaction agents 4 and 6 of FIG. 2. Such storage devices could store the program instructions between system reboots. The transaction agents 4 and 6 could also store information on one or more remote storage servers (not shown), which would also include a computer readable storage medium for storing program instructions as described herein. A further example of a computer readable data storage medium that may be used to store the program instructions would be portable optical storage disks of the type that are conventionally used for commercial software sales, such as compact disk-read only memory (CD-ROM) disks, compact disk-read/write (CD-R/W) disks, and digital versatile disks (DVDs). Examples of such media are shown by reference number 100 in FIG. 15.

Although various example embodiments have been shown and described, it should be apparent that many variations and alternative embodiments could be implemented in accordance with the disclosure. It is understood, therefore, that the invention is not to be in any way limited except in accordance with the spirit of the appended claims and their equivalents.

What is claimed is:

1. A client transaction agent coupon database interface method, comprising:
creating a shopping list in electronic form, said shopping list specifying one or more product or service items;
sending said shopping list to a server transaction agent acting as a coupon database interface, said shopping list serving as a coupon query initiated by said client transaction agent; and
receiving selected coupons in electronic form from said server transaction agent as a response to said client transaction agent's coupon query, said selected coupons being associated with some or all of said items specified in said shopping list.

2. The method of claim 1, further including informing said server transaction agent of a point-of-purchase location where said items specified in said shopping list will be purchased.

3. The method of claim 1, further including responding to one or more user inputs by denoting one or more of said selected coupons as coupons that have been chosen for coupon redemption, and responding to a further user input by presenting said chosen coupons as part of a coupon redemption operation.

4. The method of claim 1, further including notifying said server transaction agent of one or more of said selected coupons that have been chosen for redemption, and performing an action to update said shopping list based on items that have been chosen for purchase.

5. The method of claim 1, further including associating said shopping list with one or more client transaction agent users with whom said shopping list is to be shared.

6. The method of claim 1, further including associating status indicators with said product or service items, said status indicators indicating a level of said items available to a user of said client transaction agent.

7. The method of claim 6, wherein said status indicators are selected from the group consisting of flag indicators, numeric indicators and qualitative indicators.

8. A client transaction agent coupon database interface system, comprising:
one or more processors operably coupled to a memory;
program instructions stored in said memory and executable by said one or more processors to perform operations for implementing a client transaction agent coupon database interface, said operations comprising:
creating a shopping list in electronic form, said shopping list specifying one or more product or service items;
sending said shopping list to a server transaction agent acting as a coupon database interface, said shopping list serving as a coupon query initiated by said client transaction agent; and
receiving selected coupons in electronic form from said server transaction agent as a response to said client transaction agent's coupon query, said selected coupons being associated with some or all of said items specified in said shopping list.

9. The system of claim 8, wherein said operations further include informing said server transaction agent of a point-of-purchase location where said items specified in said shopping list will be purchased.

10. The system of claim 8, wherein said operations further include responding to one or more user inputs by denoting one or more of said selected coupons as coupons that have been chosen for coupon redemption, and responding to a further user input by presenting said chosen coupons as part of a coupon redemption operation.

11. The system of claim 8, wherein said operations further include notifying said server transaction agent of one or more of said selected coupons that have been chosen for redemption, and performing an action to update said shopping list based on items that have been chosen for purchase.

12. The system of claim 8, wherein said operations further include associating said shopping list with one or more client transaction agent users with whom said shopping list is to be shared.

13. The system of claim 8, wherein said operations further include associating status indicators with said product or service items, said status indicators indicating a level of said items available to a user of said client transaction agent.

14. The system of claim 13, wherein said status indicators are selected from the group consisting of flag indicators, numeric indicators and qualitative indicators.

15. A client transaction agent coupon database interface computer program product, comprising:
one or more non-transitory data storage media;
program instructions stored on said storage media and executable by one or more processors to perform operations for implementing a client transaction agent coupon database interface, said operations comprising:
creating a shopping list in electronic form, said shopping list specifying one or more product or service items;
sending said shopping list to a server transaction agent acting as a coupon database interface, said shopping list serving as a coupon query initiated by said client transaction agent; and
receiving selected coupons in electronic form from said server transaction agent as a response to said client transaction agent's coupon query, said selected coupons being associated with some or all of said items specified in said shopping list.

16. The computer program product of claim 15, wherein said operations further include informing said server transaction agent of a point-of-purchase location where said items specified in said shopping list will be purchased.

17. The computer program product of claim 15, wherein said operations further include responding to one or more user inputs by denoting one or more of said selected coupons as coupons that have been chosen for coupon redemption, and responding to a further user input by presenting said chosen coupons as part of a coupon redemption operation.

18. The computer program product of claim 15, wherein said operations further notifying said server transaction agent of one or more of said selected coupons that have been chosen for redemption, and performing an action to update said shopping list based on items that have been chosen for purchase.

19. The computer program product of claim 15, wherein said operations further include associating said shopping list with one or more client transaction agent users with whom said shopping list is to be shared.

20. The computer program product of claim 15, wherein said operations further include associating status indicators with said product or service items, said status indicators indicating a level of said items available to a user of said client transaction agent.

21. The computer program product of claim 20, wherein said status indicators are selected from the group consisting of flag indicators, numeric indicators and qualitative indicators.
